(19) United States
(12) Patent Application Publication
(10) Pub. No.: US 2014/0258025 A1
(43) Pub. Date: Sep. 11, 2014

(54) DIGITAL CONTENT RECOMMENDATION SYSTEM

(71) Applicants: Makram Bouzid, Nozay (FR); Stéphane Betge-Brezetz, Nozay (FR); Armen Aghasaryan, Nozay (FR); Julien Maisonneuve, Nozay (FR)

(72) Inventors: Makram Bouzid, Nozay (FR); Stéphane Betge-Brezetz, Nozay (FR); Armen Aghasaryan, Nozay (FR); Julien Maisonneuve, Nozay (FR)

(73) Assignee: ALCATEL LUCENT, Paris (FR)

(21) Appl. No.: 14/127,596

(22) PCT Filed: Jun. 29, 2012
(86) PCT No.: PCT/EP2012/062728

§ 371 Date: May 22, 2014

(30) Foreign Application Priority Data
Jun. 30, 2011 (FR) 1155887

(51) Int. Cl. G06Q 30/06; G06Q 20/12

(52) U.S. Cl. CPC G06Q 30/0631; G06Q 20/123
USPC 705/26.7

(57) ABSTRACT

In order to recommend digital content to be delivered via a telecommunications network (RT) to a communication terminal (TC), a device (DRA) receives a first list (L1) of digital content produced from a recommendation system (SR) based on a user's profile, each piece of digital content on the list being associated with an estimate of the user's degree of interest, and receives cost estimates respectively associated with the deliveries of digital content included in the first list from another device (DAC), the cost being representative of resources of the telecommunications network needed to deliver the digital content from a content source (SC) to the communication terminal. The device (DRA) assigns a score to each piece of digital content based on the estimate of the degree of interest associated with the digital content and the estimate of the cost associated with the delivery of digital content, and generates a second list (L2) of digital content based on the scores assigned to the digital content on the first list (L1) before transmitting the second list to the communication terminal.

The present invention pertains to a recommendation system for digital content delivered via a communication network.

Currently, services for the delivery, via a telecommunications network, of content such as video on demand or television channels, are constantly increasing, and encounter at least two critical problems. On one hand, the telecommunication network operators must manage a vast quantity of data that travel through the networks. On the other hand, users must face a vast range of content, because they are offered hundreds of television channels and thousands of videos on demand. In order to help a user find a desired piece of content, recommendation systems select content for the user, taking into account the user's preferences and habits.

Generally speaking, recommendation systems are based on analyzing user profiles and content descriptions. However, these systems do not guarantee quality of service of content delivery, or do not offer other content associated with a better quality of service.

This means there is a need to offer content with the possibility of better quality of service.

In order to remedy the aforementioned shortcomings, a method for recommending digital content to be delivered via a telecommunications network to a communication terminal comprises the following steps in a device included within the telecommunications network:
receiving a first list of digital content produced from a recommendation system based on a profile of the user, each piece of digital content on the list being associated with an estimate of the user's degree of interest,
receiving cost estimates respectively associated with the deliveries of digital content included in the first list from another device, the cost being representative of telecommunications network resources needed to deliver the digital content from a content source to the communication terminals,
assigning a score to each piece of digital content based on the estimate of the degree of interest associated with the digital content and with the cost estimate associated with the delivery of digital content.
generating a second list of digital content based on the scores assigned to the first list's digital content,
transmitting the second list to the communication terminal.

Advantageously, the invention first considers the user preferences and second considers an overall cost function for delivering the content, evenly adjusting the users' desires with the network-related costs, thereby guaranteeing a satisfactory quality of service for the recommended content. Therefore, the invention takes into consideration a network-related cost for carrying a piece of digital content, which particularly depends on the state of the network, the scarcity of the network resources used, the location of the content, and which implicitly guarantees a better quality of service for the user.

The recommendation system estimates the delivery costs of various content that may be available at a given node of the network or various nodes of the network, while taking into account the content's characteristics in addition to the network's capacity.

According to one characteristic of the invention, the score may be determined based on a sum of the estimate of the degree of interest associated with the digital content and the inverse of the cost estimate associated with the delivery of the digital content, the estimate of the degree of interest being weighted by a first factor dependent on an importance attached to the user's preferences, and the inverse of the cost being weighted by a second factor dependent on an importance attached to a digital content delivery quality.

According to another characteristic of the invention, the method may further comprise retrieving user impressions of the second list in order to adjust the first and second factors.

According to another characteristic of the invention, the first and second factors are adjusted by comparing the first list and the second list based on the digital content selected by the user.

According to another characteristic of the invention, the cost may be determined based on characteristics of digital content comprising at least the size of the digital content, the format of the digital content, and the delivery date of the digital content.

According to another characteristic of the invention, the cost may further be determined based on the bandwidth required to deliver the digital content and based on the availability of the digital content in the cache memories of the content sources.

According to another characteristic of the invention, the cost may further be determined based on parameters related to the delivery of the digital content, said parameters taking into account, at the minimum, delay, jitter, and quality of service.

According to another characteristic of the invention, the telecommunications network may be based on distributed storage or cloud computing technology in order to deliver digital content saved in different content sources.

The invention also relates to a device for recommending digital content to be delivered via a telecommunications network to a communication terminal, comprising:
means for receiving a first list of digital content produced from a recommendation system based on a profile of the user, each piece of digital content on the list being associated with an estimate of the user's degree of interest,
means for receiving cost estimates respectively associated with the deliveries of digital content included in the first list from another device, the cost being representative of telecommunications network resources needed to deliver the digital content from a content source to the communication terminal,
means for assigning a score to each piece of digital content based on the estimate of the degree of interest associated with the digital content and with the cost estimate associated with the delivery of digital content,
means for generating a second list of digital content based on the scores assigned to the first list's digital content,
means for transmitting the second list to the communication terminal.

The invention also pertains to a computer program capable of being implemented within a device, said program comprising instructions which, whenever the program is executed within said device, carry out the steps according to the inventive method.

The present invention and the benefits thereof shall be better understood upon examining the description below, which makes reference to the attached figures, in which:

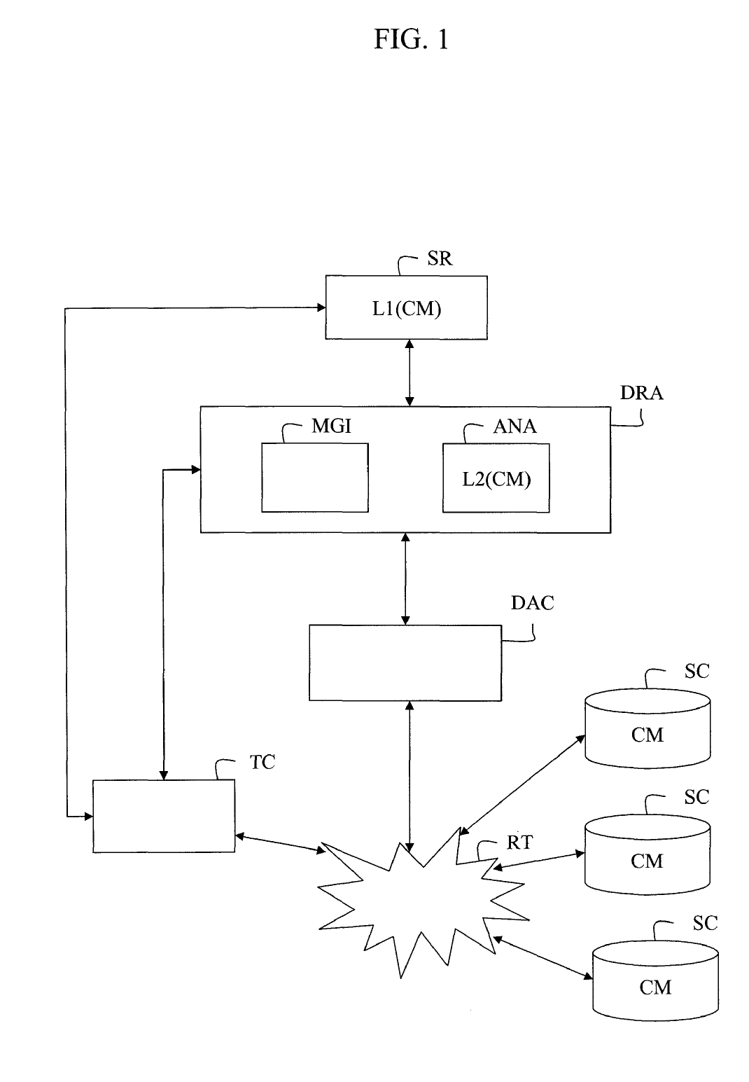

FIG. 1 is a schematic block diagram of a communication system according to one embodiment of the invention,

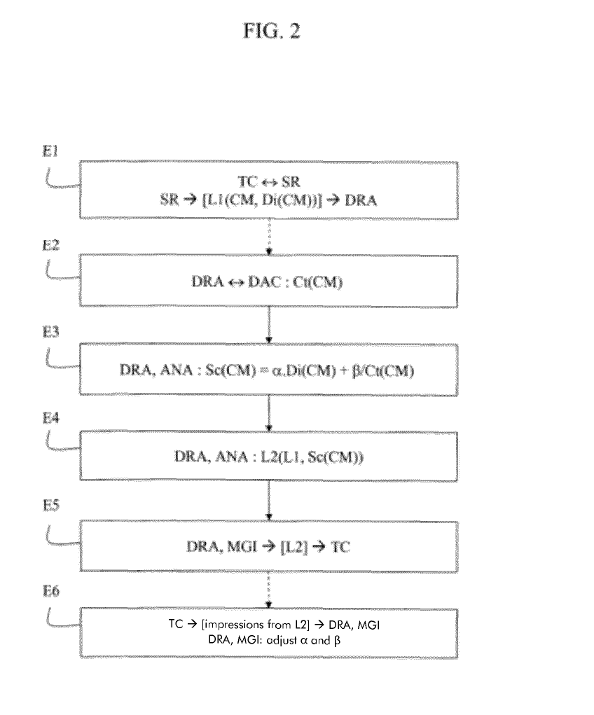

FIG. 2 is an algorithm of a method for recommending digital content delivered via a telecommunication network according to one embodiment of the invention.

With reference to FIG. 1, a communication system comprises a recommendation system SR, an advanced recommendation device DRA, a cost analysis device DAC, content sources SC, and at least one communication terminal TC, all capable of communicating with one another via a telecommunications network RT.

The telecommunication network RT may be a wired or wireless network, or a combination of wired and wireless networks.

In one example, the telecommunications network RT is a high-speed IP (Internet Protocol) packet network, such as the Internet or an intranet.

In another example, the telecommunications network RT is a TDM (Time Division Multiplexing) network or a private network specific to a company supporting a proprietary protocol.

The content sources SC host different multimedia content, for example in the form of a content provider's shop and in the form of caches for the duplication of multimedia content. The content sources SC may potentially belong to different operators.

A communication terminal TC is capable of communicating via the telecommunications network RT with the recommendation system SR and the advanced recommendation device DRA, and is capable of receiving a piece of digital content delivered by a content source over the telecommunications network RT.

In one example, a communication terminal is a personal computer directly linked by modem to an xDSL (Digital Subscriber Line) or ISDN (Integrated Services Digital Network) link connected to the telecommunication network RT.

In another example, a communication terminal is a mobile cellular radiocommunication terminal, linked to the telecommunication network by a radiocommunication channel, for example of the GSM (Global System for Mobile communications) or UMTS (Universal Mobile Telecommunications System) type.

In another example, a communication terminal comprises an electronic telecommunication device or object that may be a personal digital assistant (PDA) or a smartphone, capable of being connected to an antenna on a public wireless local area network WLAN, a network using the 802.1x standard, or a wide area network using the WIMAX (Worldwide Interoperability Microwave Access) protocol, connected to the telecommunication network.

The communication terminal TC implements an interface communicating with the recommendation system SR to request a list of recommended multimedia content. The communication terminal TC transmits a profile of the user and a usage context to the recommendation system SR. The communication terminal TC optionally transmits characteristics of the terminal TC to the recommendation system SR, the characteristics describing, for example, the terminal's capabilities to read a piece of multimedia content.

It is additionally a purpose of the interface to display a list of recommended multimedia content and to obtain impressions or comments from the user regarding the list of recommended multimedia content, by communicating with the advanced recommendation device DRA.

A piece of multimedia content CM is a piece of digital content such as an image or text and/or audio and/or video material. In the context of the invention, the multimedia content CM generally comprises video data requiring a non-negligible quantity of telecommunications network resources in order to be delivered from a content source SC to the communication terminal TC, the video data requiring more resources for certain data formats, such as high definition or 3D.

The recommendation system SR produces a first list L1 of multimedia content recommended based on the user's profile. The selection of multimedia content is executed based on available content described in a catalog provided by a database capable of listing the content available from various sources of content.

The recommendation system SR estimates a degree of interest Di(CM) of a piece of multimedia content for the user—for example, between 0 and 1—indicating a forecast of the appraisal of multimedia content CM by the user on a scale of 0 to 1, for example. Said estimate is, for example, determined based on the user's profile, the usage context, and his or her habits.

For example, the user's profile contains the user's preferences or tastes regarding types of multimedia content. If the multimedia content is a movie, the user's preferences may contain the genre of movie desired by the user, such as a crime movie. The usage context may contain the current time, the user's location, or the user's mood.

The cost analysis device DAC estimates the cost Ct(CM) of delivering a piece of multimedia content CM from a content source SC to a communication terminal TC. The cost is estimated based on the characteristics of the multimedia content, such as the size of the content, the format of the content, the delivery date, the estimated time for delivery, and the bandwidth required to deliver the multimedia content. The cost is further estimated based on the availability of the multimedia content in the memory caches of content sources SC located close to or far from the communication terminal TC within the telecommunications network RT. The cost is further estimated based on the state of the telecommunications network RT, taking into account, for example, the load, congestion, or available bandwidth.

The role of the cost function is to obtain an overall optimization of all recommendations given to the user in order to avoid any congestion of the telecommunication network that would lead to poor quality in delivering multimedia content to the user. For example, the user could be disappointed by a recommended piece of multimedia content, even if it corresponds to preferences in his or her user profile, if its delivery is of poor quality, delayed, or affected by jitter. Thus, the cost function may further take into consideration parameters related to the delivery of the digital content, such as delay, jitter, or a quality of service indicator such as the video quality indicator PEVQ (Perceptual Evaluation of Video Quality).

The cost function further takes into consideration the inherent flexibility of the telecommunications network, which may be based on cloud computing or distributed storage (such as CDN, or Content Delivery Network) technology, within the scope of the invention, that is capable of delivering multimedia content from different content sources SC.

For a telecommunications network operator, the cost function may depend on multiple parameters that relate to resources, such as the use of a particular “cache” network element or the use of bandwidth. It is assumed that the cost function assigns a maximum weight to resources considered scarce, which must be preserved at given moments for the network to properly function.

Furthermore, the cost function may take into account the characteristics of the communication terminal TC, describing, for example, the capabilities of the terminal TC to play a piece of multimedia content. In one embodiment, two video files that correspond to the same movie in two different formats may be considered to be two different pieces of multimedia content.

The advanced recommendation device DRA comprises an impression management module MGI and an analysis module ANA.

The analysis module ANA of the advance recommendation device DRA uses as input the first list L1 of recommended multimedia content provided by the recommendation system SR and analyzes the estimate Di(CM) and cost Ct(CM) for each piece of multimedia content CM on the list. To that end, the advanced recommendation device DRA asks the cost analysis device DAC to transmit to it a cost estimate Ct(CM) for each piece of multimedia content included in the first list L1.

For each piece of multimedia content CM, the analysis module ANA determines a score Sc(CM) based on the following function: Sc(CM)=α.Di(CM)+β/Ct(CM), such that α+β=1. For example, the factor α corresponds to a maximum importance attached to the user's preferences and the factor β corresponds to a maximum importance attached to a minimum cost of delivering multimedia content, i.e. a maximum quality for delivering multimedia content. The factors α and β may be chosen and adjusted based on the importance attached to the user's preferences or a maximum desired quality.

The analysis module ANA selects a given number of pieces of multimedia content from the list that had the best scores and generates a second list L2 of recommended multimedia content based on selected multimedia content.

The impression management module MGI may use as input the first list L1 and the second list L2. The function of the module MGI is to transmit the second list L2 to the communication terminal TC and to retrieve the user's impressions from the second list L2 in order to adjust the factors α and β.

The module MGI may adjust the factors α and β according to multiple non-limiting possibilities.

In the first possibility, the module MGI may check the position of the multimedia content selected in the second list L2 by the user and compare that position to that of the same content in the first list L1. This operation may be repeated in order to decide, for example, whether to increase the value of the factor α in the event that the selected content is generally better-ranked in the first list, or to decide, for example, to increase the value of the factor β in the event that the selected content does not correspond to a satisfactory quality of service.

In a second possibility, the module MGI may transmit both the first list L1 and the second list L2 to the communication terminal TC in order to ask the user what list he or she prefers. This operation may be repeated in order to draw conclusions from the values of factors α and β.

In a third possibility, the module MGI may alternatively transmit the first list L1 and the second list L2 to the communication terminal TC in order to implicitly deduce from it which list the user prefers.

In one variant, the advanced recommendation device DRA and the cost analysis device DAC are included in the same device.

With reference to FIG. 2, a method for recommending digital content delivered via a telecommunication terminal according to one embodiment of the invention comprises steps E1 to E6 executed within the communication system.

In step E1, a user wishes to view a piece of multimedia content via a communication terminal TC, and requests from the recommendation system SR a recommendation about multimedia content that the user might enjoy.

The communication terminal TC then transmits a profile of the user and a usage context to the recommendation system SR. If that system already has this information, the user may be prompted, for example, to activate his or her profile. The recommendation system SR produces a first list L1 of multimedia content

CM recommended based on the user's profile. For each piece of multimedia content included in the first list, the recommendation system SR determines an estimate of a degree of interest Di(CM) in the multimedia content by the user, and associates that estimate with the multimedia content. The advanced recommendation device DRA, capable of communicating directly with the system SR, then retrieves that first list L1.

In step E2, the advanced recommendation device DRA asks the cost analysis device DAC to transmit to it a cost estimate Ct(CM) for each piece of multimedia content included in the first list L1. The cost is considered representative of telecommunications network RT resources needed to deliver the digital content from a content source SC to the communication terminal TC.

In step E3, the analysis module ANA of the advanced recommendation device DRA determines for each piece of multimedia content CM a score Sc(CM) based on the following function: Sc(CM)=α.Di(CM)+β/Ct(CM), such that α+β=1. The module ANA thereby assigns a score to each piece of multimedia content based on the estimate of the degree of interest Di(CM) associated with the multimedia content and the cost estimate Ct(CM) associated with delivering the multimedia content. In other words, the score assigned to a piece of multimedia content is based on a sum of the estimate of the degree of interest Di(CM) and the negative value of the cost estimate Ct(CM) associated with the multimedia content, the estimate of the degree of interest Di(CM) being weighted by a factor α that depends on an importance attached to the user's preferences and the negative value of the cost estimate Ct(CM) being weighted by a factor β dependent on an importance attached to a quality of delivering the multimedia content. It is assumed that the best scores are the highest scores, as the estimate of the degree of interest must have the highest possible value and the cost estimate must have the lowest possible value.

In step E4, the analysis module ANA generates a second list L2 of multimedia content recommended based on the scores Sc assigned to the multimedia content on the first list L1. More particularly, the analysis module ANA selects a given number of pieces of multimedia content on the list that have the best scores, i.e. the highest scores, and generates a second list L2 of recommended multimedia content based on the selected multimedia content.

It is assumed that the second list L2 comprises at most the same number of pieces of multimedia content as those on the first list L1.

In step E5, the impression management module MGI of the device DRA transmits the second list L2 of recommended multimedia content to the communication terminal TC.

In step E6, which can be repeated, the impression management module MGI retrieves the user's impressions from the second list L2 in order to adjust the factors α and β.

In particular, the factors α and β may be adjusted by comparing the first list L1 and the second list L2 based on the digital content selected by the user.

The invention described here relates to a method and device for recommending digital content delivered via a telecommunication network. According to one embodiment of the invention, the steps of the inventive method are determined by the instructions of a computer program incorporated into a device, such as the advanced recommendation device DRA. The program comprises program instructions that, when said program is loaded and executed within the server, carry out the steps of the inventive method.

Consequently, the invention also applies to a computer program, particularly a computer program on or within an information medium, suitable to implement the invention. This program may use any programming language, and be in the form of source code, object code, or intermediate code between source code and object code, such as in a partially compiled form, or in any other form desirable for implementing the inventive method.

1. A method for recommending digital content to be delivered via a telecommunications network to a communication terminal comprises the following steps in a device included within the telecommunications network:
receiving a first list of digital content produced from a recommendation system based on a profile of the user, each piece of digital content on the list being associated with an estimate of the user's degree of interest,
receiving cost estimates respectively associated with the deliveries of digital content included on the first list from another device, the cost being representative of resources of the telecommunications network needed to deliver the digital content from a content source to the communication terminal,
assigning a score to each piece of digital content based on the estimate of the degree of interest associated with the digital content and with the estimate of the cost associated with the delivery of digital content,
generating a second list of digital content based on the scores assigned to the first list's digital content,
transmitting the second list to the communication terminal.

2. A method according to claim 1, whereby the score is determined based on a sum of the estimate of the degree of interest associated with the digital content and the negative value of the cost estimate associated with the delivery of the digital content, the estimate of the degree of interest being weighted by a first factor dependent on an importance attached to the user's preferences, and the negative value of the cost being weighted by a second factor dependent on an importance attached to a digital content delivery quality.

3. A method according to claim 2, further comprising a retrieval of the user's impressions from the second list in order to adjust the first and second factors.

4. A method according to claim 3, whereby the first and second factors are adjusted by comparing the first list and the second list based on the digital content selected by the user.

5. A method according to claim 1, whereby the cost is determined based on characteristics of the digital content comprising at least the size of the digital content, the format of the digital content, the delivery date of the digital content.

6. A method according to claim 1, whereby the cost is further determined based on the bandwidth required to deliver the digital content and based on the availability of the digital content in the cache memories of the content sources

7. A method according to claim 1, whereby the cost is further determined based on the parameters related to delivering the digital content, said parameters comprising at least one delay, one jitter, and one quality of service indicator.

8. A method according to claim 1, whereby the telecommunications network is based on a distributed storage technology capable of delivering digital content saved in different content sources.

9. A method according to claim 1, whereby the telecommunications network is based on a cloud computing technology capable of delivering digital content saved in different content sources.

10. A device for recommending digital content to be delivered via a telecommunications network to a communication terminal, comprising:
means for receiving a first list of digital content produced from a recommendation system based on a profile of the user, each piece of digital content on the list being associated with an estimate of the user's degree of interest,
means for receiving cost estimates respectively associated with the deliveries of digital content included on the first list from another device, the cost being representative of resources of the telecommunications network needed to deliver the digital content from a content source to the communication terminal,
means for assigning a score to each piece of digital content based on the estimate of the degree of interest associated with the digital content and with the cost estimate associated with the delivery of digital content,
means for generating a second list of digital content based on the scores assigned to the first list's digital content,
means for transmitting the second list to the communication terminal.

11. A computer program capable of being implemented within a device for recommending digital content to be delivered via a telecommunications network to a communication terminal, said program comprising instructions which, whenever the program is executed within said device, carry out the following:
receiving a first list of digital content produced from a recommendation system based on a profile of the user, each piece of digital content on the list being associated with an estimate of the user's degree of interest,
receiving cost estimates respectively associated with the deliveries of digital content included on the first list from another device, the cost being representative of resources of the telecommunications network needed to deliver the digital content from a content source to the communication terminal,
assigning a score to each piece of digital content based on the estimate of the degree of interest associated with the digital content and with the estimate of the cost associated with the delivery of digital content,
generating a second list of digital content based on the scores assigned to the first list's digital content,
transmitting the second list to the communication terminal.
